(19) United States
(12) Patent Application Publication
(10) Pub. No.: US 2005/0085238 A1
(43) Pub. Date: Apr. 21, 2005

(54) Output-device action call-up by mobile radio devices

(76) Inventor: Dr Christian Prehofer, Munchen (DE)

Correspondence Address: BELL, BOYD & LLOYD, LLC, P. O. BOX 1135, CHICAGO, IL, 60690-1135, US

(21) Appl. No.: 10/505,243

(22) PCT Filed: Feb. 18, 2003
(86) PCT No.: PCT/DE03/00508

(30) Foreign Application Priority Data
Feb. 20, 2002 (DE) 102 08 197.2

(51) Int. Cl. H04Q 7/20

(52) U.S. Cl. 455/456.1

(57) ABSTRACT

A method is provided for calling up actions on output devices which are controlled by a center, wherein a request is transmitted from a mobile radio device to the centre, the position of the mobile radio device is determined and available output devices are determined therefrom. A respective transaction number is displayed on the available output devices and the action is performed by inputting the transaction number on the mobile radio device or on the output device.

### BACKGROUND OF THE INVENTION

The present invention relates to a method for calling-up actions on output devices which are controlled by a center.

In the future, mobile radio devices and mobile data processing terminals having a radio interface will be able to support various possibilities for mobile transactions. In this context, it often will be necessary to provide an output at another device or allow the user to access a service at another device. In such a scenario, a center (e.g., a bank), manages a large number of devices. Examples of this are as follows:
The user wants to print out a document on a public printer which is controlled via a central print service in the network.
The user wants to purchase a drink at an automatic merchandising machine via a central service.
The user wants to play at an automatic gaming machine and account for this via a central service.
The user wants to print out an account statement at a local statement printer via the central service of the bank.
The user wants to send a fax or produce a copy of a fax via a suitable device.

The advantage of the central service is that the user only requires one uniform contact address whereat the user can manage the user's account. In these scenarios, the problem which presents itself is that the user logs on to a central service, but the central service manages a large number of output devices. Since the location of the user often is not precisely known, the correct output device must be determined. Even if the output device is precisely known, it often is not possible to specify the desired output device itself, e.g., if two output devices are directly adjacent to each other.

In order to call up an action on an output device, the output device can be identified via a multi-digit identification number. However, this is complicated for the user and is prone to error.

The present invention addresses the problem of specifying a method for calling up actions on output devices, with the method being easy for the user to use.

### SUMMARY OF THE INVENTION

Accordingly, the present invention assumes a center which controls a multiplicity of output devices such as printers, automatic drink merchandising machines, fax machines and other similar devices, for example. The actual user uses a mobile radio device or mobile telephone which allows the user to communicate wirelessly with the center.

Additional features and advantages of the present invention are described in, and will be apparent from, the following Detailed Description of the Invention.

### DETAILED DESCRIPTION OF THE INVENTION

The following steps are executed in the inventive method for calling up actions on output devices:
1. The user logs on to a center via the user's mobile radio device and requests the output. The steps which are necessary in this context (e.g., authentication), are of secondary importance to the present invention and are not described in further detail here.
2. The center determines the location of the user and specifies the output devices concerned. The location can be ascertained via the mobile radio operator or external services, for example. The relevant output devices are all those devices which are not currently in use and which are, for example, within reach of the user.
3. A transaction number, which is uniquely generated for this request and this mobile radio device or for the user, is displayed on each of these output devices. This number can be used to determine the device which is desired by the user.
4. The user enters one of the transaction numbers on the user's mobile radio device, and this number is transmitted to the center.
5. The center can determine the selected output device on the basis of this number, and initiate the output or the availability of a service there.

If another user enters a transaction number which was not generated for the user, an incorrect action at the output device can be prevented by virtue of the assignment of the number to the mobile radio device.

The inventive method also ensures that the user is actually present at the device, and that an operator error has not taken place. The transaction numbers preferably are always allocated anew and are only activated as valid for a short time span.

If a keyboard or other input device is present at the output device, the transaction number also can be input directly at the output device itself.

The inventive method does not require an input medium or communication medium at the output device, since the mobile radio device of the user does not communicate directly with the output device.

The transaction number can be significantly shorter than the identification number of the output device, thereby reducing the effort for the user and the possibility of operator error.

Although the present invention has been described with reference to specific embodiments, those of skill in the art will recognize that changes may be made thereto without departing from the spirit and scope of the present invention as set forth in the hereafter appended claims.

1. (canceled).

2. A method for calling up actions on output devices controlled from a center, the method comprising:
sending a request from a mobile radio device to the center, wherein a position of the mobile radio device and the output devices which can be accessed therefrom are determined;
displaying a respective transaction number for each of the accessible output devices; and
effecting an action by entering the respective transaction number at one of the mobile radio device and the respective output device.
